(19) United States
(12) Patent Application Publication
(10) Pub. No.: US 2026/0085943 A1
(43) Pub. Date: Mar. 26, 2026

(54) INFORMATION PROCESSING APPARATUS

(71) Applicant: TOYOTA JIDOSHA KABUSHIKI KAISHA, Toyota-shi (JP)

(72) Inventor: Yu NAGATA, Tokyo-to (JP)

(73) Assignee: TOYOTA JIDOSHA KABUSHIKI KAISHA, Toyota-shi (JP)

(21) Appl. No.: 19/330,136

(22) Filed: Sep. 16, 2025

(30) Foreign Application Priority Data
Sep. 26, 2024 (JP) 2024-167839

(51) Int. Cl. G01C 21/36

(52) U.S. Cl. CPC G01C 21/3629

(57) ABSTRACT

The controller of the information processing apparatus obtain the current location of the vehicle. The controller of the information processing apparatus calculates the current distance from the current location of the vehicle to the destination of the vehicle. The controller of the information processing apparatus causes the voice output device to output a voice data generated using the content information according to the current distance. The content information is selected from a plurality of candidates of the content information posted on a website related to an event to be held at the destination of the vehicle.

### CROSS REFERENCE TO THE RELATED APPLICATION

This application claims the benefit of Japanese Patent Application No. 2024-167839, filed on Sep. 26, 2024, which is hereby incorporated by reference herein in its entirety.

### BACKGROUND

### Technical Field

The present disclosure relates to an information processing apparatus.

### Description of the Related Art

Patent Literature 1 discloses an in-vehicle car navigation and promotion delivery system. The in-vehicle car navigation and promotion delivery system includes a voice recognition device that extracts destinations, user preferences and user personal information from voice of speech in the vehicle. The in-vehicle car navigation and promotion delivery system also includes a navigation module configured to receive information regarding a user's current location, a destination, and location-dependent navigation information, and to generate navigation instructions based on the navigation information, the current location, and the destination.

The in-vehicle car navigation and promotion delivery system also includes a promotion module that infers user interests from the destination, user preferences, and user personal information, and selects promotion offers based on the user interest inference result. The in-vehicle car navigation and promotion delivery system also includes a dialogue manager that receives navigation instructions, promotion offers, and necessary information required for the promotion module to determine whether to select the promotion offers, and generates prompts to present the navigation instructions, promotion offers, and necessary information to the user.

The in-vehicle car navigation and promotion delivery system also includes a voice generating device that generates voices within the vehicle based on the generated prompts. The promotion module then receives the user's voice in response to the prompt generated based on the required information, and further infers user interests based on the required information extracted from the user's voice.

### CITATION LIST

### Patent Literature

Patent Literature 1: Japanese Patent Application Laid-Open No. 2006-510004

### SUMMARY

An object of the present disclosure is to provide a vehicle user with suitable information at a suitable timing.

An information processing apparatus according to a first aspect of the present disclosure may include a controller configured to execute:
obtaining a current location of a vehicle;
calculating a current distance from the current location of a vehicle to a destination of the vehicle;
outputting, from a sound output device, a voice data generated using a content information according to the current distance;
the content information may be selected according to the current distance from among a plurality of candidates of the content information published on a website related to an event to be held at the destination of the vehicle.

According to the present disclosure, it is possible to provide suitable information to a vehicle user at a suitable timing.

### BRIEF DESCRIPTION OF THE DRAWINGS

FIG. 1 is a diagram illustrating a schematic configuration of a voice guidance system.

FIG. 2 is a block diagram schematically illustrating an example of a functional configuration of the in-vehicle apparatus.

FIG. 3 is a diagram illustrating an example of a table configuration of keyword information held in the keyword information database.

FIG. 4 is a flowchart of the generation process executed by the controller of the in-vehicle apparatus.

FIG. 5 is a flowchart of the output process executed by the controller of the in-vehicle apparatus.

### DESCRIPTION OF THE EMBODIMENTS

Events may be held at the vehicle's destination. In such a case, a service may be provided that provides voice guidance to the vehicle user regarding events to be held at the destination while the vehicle is traveling. However, if the vehicle is located in a location far from the destination, it will take longer to reach the destination than if the vehicle is located in a location close to the destination. In other words, the time it takes to reach the destination varies depending on the vehicle's location. Therefore, it is expected that the information required by the vehicle user will differ depending on the vehicle's location.

Therefore, a controller of an information processing apparatus according to the present disclosure obtain a current location of a vehicle. The controller of the information processing apparatus according to the present disclosure calculates a current distance from the current location of the vehicle to a destination of the vehicle. The controller causes an audio output device in the vehicle to output voice data generated using a content information in accordance with the calculated current distance. The content information may be selected from a plurality of candidates of content information present on a website related to an event held at the vehicle's destination according to the current distance.

As described above, in the information processing apparatus according to the present disclosure, voice data is output according to the current distance. This makes it possible to provide information that is expected to be required by the vehicle user according to the vehicle's location. As a result, it is possible to provide the vehicle user with suitable information at a suitable time.

Hereinafter, specific embodiments of the present disclosure will be described with reference to the drawings Unless otherwise specified, the hardware configurations, module configurations, functional configurations, and the like described in the following embodiments are not intended to limit the technical scope of the present disclosure to only those.

### EMBODIMENT

### System Overview

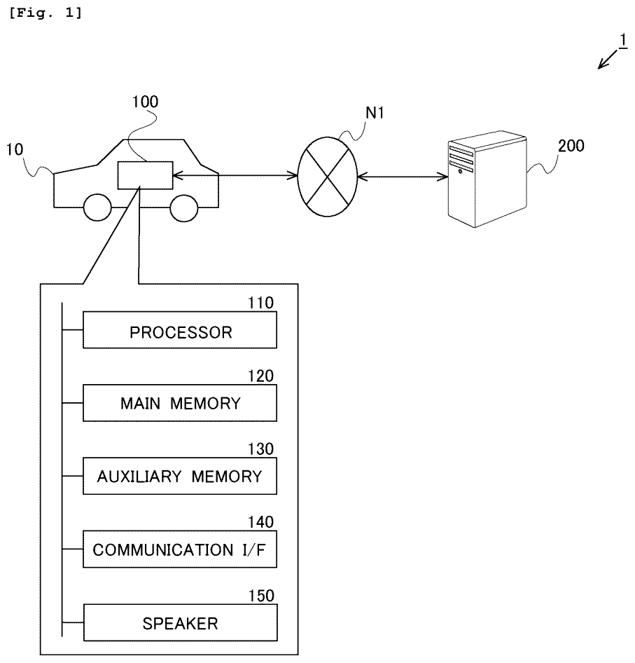

A voice guidance system 1 according to the present embodiment will be described with reference to FIG. 1. FIG. 1 is a diagram illustrating a schematic configuration of the voice guidance system 1. The voice guidance system 1 includes an in-vehicle apparatus 100 and a web server 200. In the voice guidance system 1, the in-vehicle apparatus 100 and the web server 200 are connected to each other via a communication network N1. The communication network N1 may be, for example, a WAN (Wide Area Network) which is a global public communication network such as the Internet, or a telephone communication network such as a mobile phone.

### Web Server

The web server 200 is a server apparatus that provides a website related to the event. The web server 200 provides a website relating to the event by transmit data for displaying the website via communication network N1.

### In-vehicle Apparatus

The in-vehicle apparatus 100 is a computer mounted on the vehicle 10. The in-vehicle apparatus 100 presents information to the user of the vehicle 10. The in-vehicle apparatus 100 may be configured, for example, by combining a car navigation system and a DCM (Data Communication Module) mounted on the vehicle 10.

In the present embodiment, when an event is held at the destination of the vehicle 10 (the destination of the user of the vehicle 10), the in-vehicle apparatus 100 provides voice guidance regarding the event to the user of the vehicle 10 while the vehicle 10 is traveling.

Incidentally, when the vehicle 10 is located in a location far from the destination, it takes longer to reach the destination than when the vehicle 10 is located in a location close to the destination. In other words, the time it takes to reach the destination varies depending on the location of the vehicle 10. Therefore, if voice guidance is provided regarding details of the event when the vehicle 10 is location far from the destination, there is a possibility that the user will forget the content of that information when vehicle 10 arrives at the destination.

Therefore, the in-vehicle apparatus 100 of the present embodiment is configured to change the content of information provided by voice guidance depending on the distance from current location of the vehicle 10 to the destination. Specifically, the in-vehicle apparatus 100 in the present embodiment is configured to provide voice guidance on information regarding an overview of the event when the distance from the current location of the vehicle 10 to the destination is long, and to provide voice guidance on information regarding details of the event when the distance from the current location of the vehicle 10 to the destination is short.

This allows more detailed information about the event to be provided as the vehicle 10 approaches the destination. As a result, the user of the vehicle 10 is less likely to forget the details of the event and can feel more excited about the event.

Here, the information regarding the overview of the event is information regarding an outline of a holding of the event. The outline of a hosting of the event may be, for example, information regarding the location (destination) of the event or the start time of the event. The information regarding the details of the event is more detailed than information regarding the overview of the event. In one example, the information regarding the details of the event may be information regarding the latest updates, performers at the event, or the times when the performers will be appearing, etc. The information regarding the details of the event may include information regarding businesses participating in the event, or information regarding businesses sponsoring the event, and the like.

Details of a method in which the in-vehicle apparatus 100 provides voice guidance regarding information regarding the overview of the event and details of the event will be described later.

The in-vehicle apparatus 100 is composed of a computer including a processor 110, a main memory 120, an auxiliary memory 130, a communication interface (communication I/F) 140, and a speaker 150. The processor 110 is, for example, a central processing unit (CPU) or a digital signal processor (DSP). The main memory 120 is, for example, a RAM (Random Access Memory). The auxiliary memory 130 is, for example, a ROM (Read Only Memory). The auxiliary memory 130 may include, for example, a HDD (Hard Disk Drive), or a disk recording medium such as a CD-ROM, a DVD disk, or a Blu-ray disk. The auxiliary memory 130 may include a removable medium. The removable medium may be, for example, a USB memory or an SD card. The communication I/F 140 is, for example, a local area network (LAN) interface board or a wireless communication circuit for wireless communication. The speaker 150 is a device for outputting audio within the vehicle 10 and is an example of an “audio output device” according to the present disclosure.

The auxiliary memory 130 of the in-vehicle apparatus 100 stores an operating system (OS), various programs, various information tables, and the like. The processor 110 of the in-vehicle apparatus 100 loads a program stored in the auxiliary memory 130 into the main memory 120 and executes the program, thereby achieving various functions as described below. However, some or all of the functions of the in-vehicle apparatus 100 may be realized by a hardware circuit such as an ASIC or an FPGA. The in-vehicle apparatus 100 does not necessarily have to be realized by a single computer, but may be realized by a plurality of computers that work in cooperation with each other. In addition, the web server 200 includes a computer like the in-vehicle apparatus 100.

### Functional Configuration

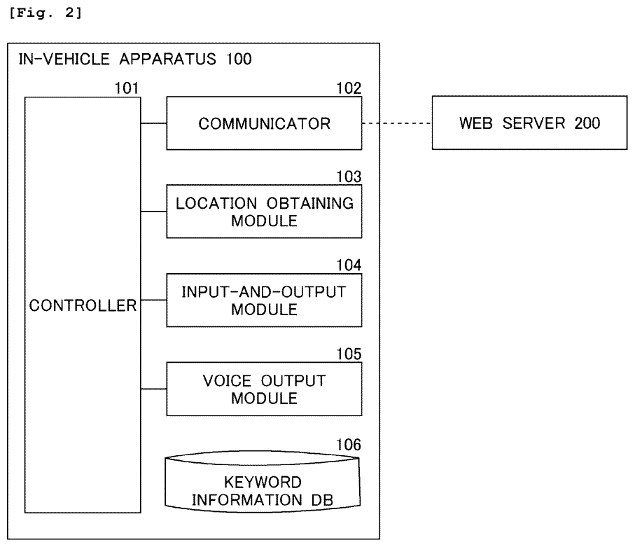

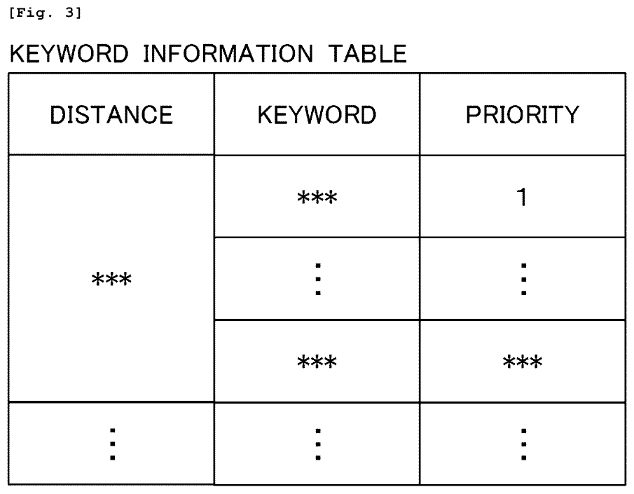

Next, the functional configuration of the in-vehicle apparatus 100 according to the present embodiment will be described with reference to FIG. 2 and FIG. 3. FIG. 2 is a block diagram illustrating an example of the functional configuration of the in-vehicle apparatus 100. The in-vehicle apparatus 100 includes controller 101, communicator 102, location obtaining module 103, input-and-output module 104, a voice output module 105, and a keyword information database 106 (keyword information DB 106).

The controller 101 has a function of performing calculation processing for controlling the in-vehicle apparatus 100. The controller 101 is realized by the processor 110 of the in-vehicle apparatus 100. The communicator 102 has a function of connecting the in-vehicle apparatus 100 to the communication network N1. The communicator 102 is realized by the communication I/F 140 of the in-vehicle apparatus 100.

The location obtaining module 103 has a function of obtain the current location of the vehicle 10 (the in-vehicle apparatus 100). The location obtaining module 103 is realized by an interface or the like for obtain the current location of the vehicle 10 from a GPS sensor mounted on the vehicle 10. The location obtaining module 103 may be realized by a GPS sensor built into the in-vehicle apparatus 100. The controller 101 obtain the current location of the vehicle 10 in real time via the location obtaining module 103. This enables the controller 101 to accurately grasp the current location of the vehicle 10.

The input-and-output module 104 has a function for the user of the vehicle 10 to input various information to in-vehicle apparatus 100. The input-and-output module 104 also has the function for displaying various information to the user of the vehicle 10. The input-and-output module 104 is realized by a touch panel display provided in in-vehicle apparatus 100.

The controller 101 obtain the destination of the vehicle 10 via the input-and-output module 104. The controller 101 accesses the web server 200 via the communicator 102 to access a website related to an event to be held at the destination of the vehicle 10. At that time, the controller 101 may access the web server 200 by searching for events to be held at the destination.

The controller 101 searches for a predetermined keyword in the accessed website. The predetermined keyword is associated with the distance from the vehicle 10 to the destination. An information relating to such the predetermined keywords is stored in advance in the keyword information DB 106 as keyword information.

The keyword information DB 106 is a database that holds keyword information. The keyword information DB 106 is constructed in the auxiliary memory 130 of the in-vehicle apparatus 100. FIG. 3 is a diagram illustrating an example of a table configuration of keyword information held in the keyword information DB 106. In the example indicate FIG. 3, the keyword information DB 106 stores a keyword information table. The keyword information table has a distance field, a keyword field, and a priority field.

The distance field stores information indicating the distance from the vehicle 10 to the destination. The information stored in the distance field may include multiple distances. In this case, the keyword field may store a plurality of keywords (predetermined keywords) corresponding to each of the plurality of distances stored in the distance field. The priority field may store the priorities of the multiple keywords stored in the keyword field.

The controller 101 extracts the predetermined keyword from the keyword information stored in the keyword information DB 106, and searches a website related to the event using the extracted predetermined keyword. When a plurality of keywords are registered in the keyword field of the keyword information DB 106, the extraction of the predetermined keyword may be performed according to the priority stored in the priority order field of the keyword information DB 106. That is, the controller 101 may repeatedly perform searches while changing the predetermined keyword in accordance with the priority until content corresponding to the predetermined keyword is found within a website related to the event. Then, when content corresponding to a predetermined keyword is found, the controller 101 extracts information about that content. Note that, the predetermined keyword is extracted from a keyword field that matches the distance from the vehicle 10 to the destination. This makes it possible to extract different content information depending on the distance from the vehicle 10 to the destination. Note that, if no content corresponding to the predetermined keyword is found, extraction of content information in the corresponding distance may be omitted.

Here, the search using the predetermined keyword may be performed by searching for link pages tagged with the predetermined keyword from among the source code of the website acquired from the web server 200. Then, the controller 101 may acquire, as predetermined information, information contained in the linked page tagged with the predetermined keyword.

In the present embodiment, the controller 101 performs a search using keywords corresponding to a first distance and a second distance, and extracts content information corresponding to the first distance and content information corresponding to the second distance. Here, the second distance is shorter than the first distance. Therefore, in order to extract content information according to the first distance, the controller 101 searches for link pages that include keywords relating to an overview of the event. In this case, the predetermined keyword is, for example, “outline of a holding”. In addition, the controller 101 searches for a link page that includes a keyword related to the details of the event in order to extract content information according to the second distance. In this case, the predetermined keywords are, for example, “latest information” and “event details” etc. . . In this manner, the controller 101 extracts content information according to the current distance from among a plurality of candidates of content information present on the website.

The controller 101 generates first voice data from the extracted first content information (content information according to the first distance). Furthermore, the controller 101 generates second voice data from the extracted second content information (content information according to the second distance). Specifically, the controller 101 generates voice data for reading out the sentences included in each of the first content information and the second content information.

Here, it is possible that the amount of the content information exceeds a threshold value.

The amount of information in the content information exceeds the threshold value, for example, may mean that the amount of text included in the content information is equal to or greater than a predetermined amount.

In such a case, if voice data generated from content information with the amount of information exceeding the threshold value is output, the voice guidance becomes long due to the large amount of information. This may cause confusion to the user of the vehicle 10 when receiving the long voice guidance. Additionally, a lengthy voice guidance may cause the user of the vehicle 10 to lose interest in the voice guidance. Therefore, when the amount of information of the content information exceeds a threshold value, the controller 101 performs a summary processing on the content information and generates voice data. In one example, the controller 101 may perform a summary process of the content information using a known summary AI.

The voice output module 105 has a function for outputting various voice to the user of the vehicle 10. The voice output module 105 is realized by a speaker 150 of the in-vehicle apparatus 100. The controller 101 outputs the generated voice data to voice output module 105. Specifically, the controller 101 converts the voice data into a voice output signal and outputs it to the voice output module 105. This allows voice guidance to be provided within the vehicle 10.

The controller 101 outputs the voice data at a predetermined timing. The predetermined timing according to the present embodiment differs between the first voice data and the second voice data. The controller 101 sets a timing at which a predetermined condition is satisfied in a state in which the distance between the current location of the vehicle 10 and the destination (current distance) is not longer than a first distance and longer than a second distance, as the predetermined timing. That is, the controller 101 permits output of the first voice data at a timing when the current distance is not longer than the first distance and the current distance is longer than the second distance and the predetermined condition is satisfied.

Furthermore, the controller 101 sets a timing at which a predetermined condition is satisfied in a state in which the current distance is not longer than the second distance, as the predetermined timing. That is, the controller 101 permits output of the second voice data at the timing when the current distance is not longer than the second distance and the predetermined condition is satisfied.

The predetermined condition according to the present embodiment is that a predetermined range from the current location of the vehicle 10 does not include any point at which voice guidance (route guidance) regarding the route to the destination is provided. The predetermined range is a range a predetermined distance before the point where route guidance is provided. The controller 101 refers to information indicating a scheduled travel route of the vehicle 10 and a timing of route guidance, and determines whether or not a location at which voice guidance (route guidance) regarding the route to the destination is provided is included within the predetermined range from the current location of the vehicle 10. This makes it possible to prevent the first voice data or the second voice data from being output at a timing when route guidance is required.

The predetermined range may be a range a predetermined distance ahead from the point where route guidance is provided. This makes it possible to prevent the first voice data or the second voice data from being output immediately after the route guidance has been provided. As a result, it is possible to prevent the first voice data or the second voice data from being output while the user of the vehicle 10 is concentrating on driving in order to follow the route guidance.

The predetermined condition may be that no curved road is included within a predetermined range from the current location of the vehicle 10. This makes it possible to prevent the first voice data or the second voice data from being output at a time when the user of the vehicle 10 is concentrating on driving. In this case, the predetermined range may be a range a predetermined distance before the start point of the curved road. This makes it possible to prevent the first voice data or the second voice data from being output at a time when the user of the vehicle 10 is concentrating on driving on a curved road. The predetermined range may also be a range a predetermined distance ahead from the end point of the curved road. This allows the first voice data or the second voice data to be output at a timing when the user of the vehicle 10 is free from tension regarding driving on a curved road.

### Generation Process

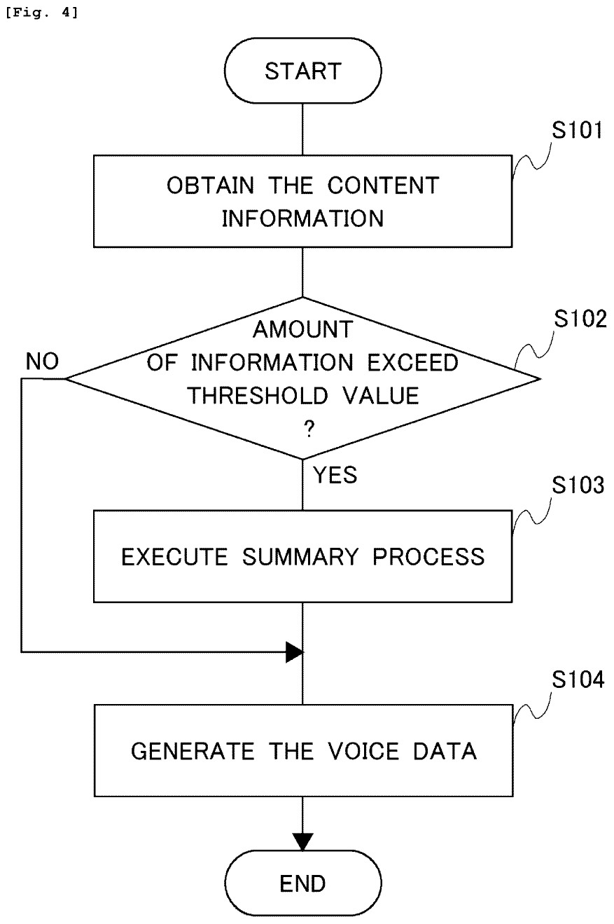

A generation process executed by controller 101 of the in-vehicle apparatus 100 of the voice guidance system 1, will be described with reference to FIG. 4. FIG. 4 is a flowchart of the generation process executed by the controller 101. The generation process is a process for generating voice data (first voice data and second voice data) according to the current distance.

In the generation process, first, in S101, content information (first content information or second content information) according to the current distance is obtained (selected) from the website. Next, in S102, it is determined whether or not the amount of the content information exceeds a threshold value. If a positive determination is made in S102, the summary process of the content information is executed in S103. Then, in S104, the voice data (the first voice data or the second voice data) is generated using the content information that has been subjected to the summary process. When the generation of the voice data (the first voice data or the second voice data) is completed, the generation process of FIG. 4 ends.

In a case where a negative determination is made in S102, the amount of information is appropriate, so that the summary process is omitted and the process of S104 is executed. After the process of S104 is completed, the generation process of FIG. 4 ends.

In the example of FIG. 4, if the amount of information exceeds the threshold value in the process of S102, the positive determination is made. On the other hand, if the amount of information is less than the threshold value in the process of S102, the negative determination is made. However, a case may be conceivable in which the amount of information coincides with the threshold value. In that case, the positive determination may be made, or the negative determination may be made.

### Output Process

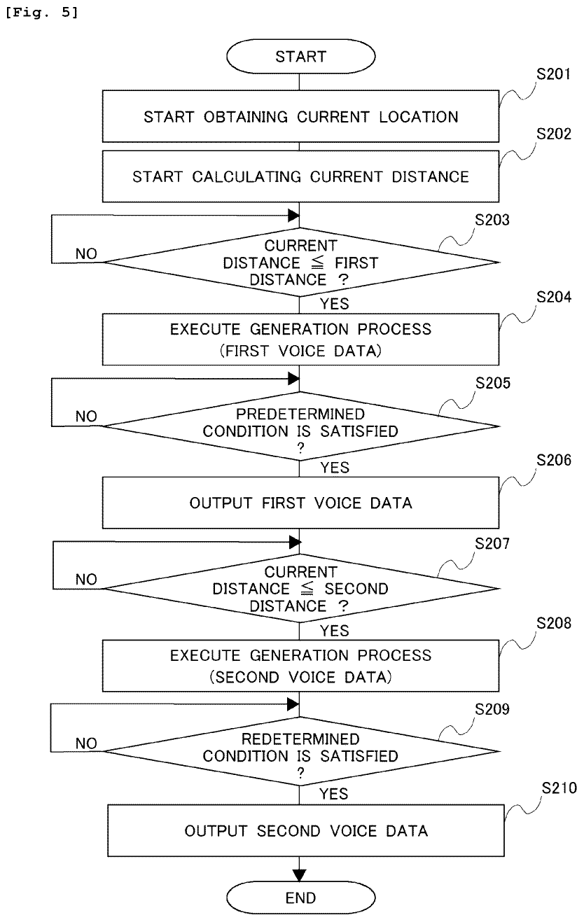

Next, an output process executed by controller 101 of the in-vehicle apparatus 100 of the voice guidance system 1 will be described with reference to FIG. 5. FIG. 5 is a flowchart of the output process executed by the controller 101. The output process is a process for causing the voice output module 105 to output the first voice data and the second voice data. The output process is executed when the user inputs the destination into the input-and-output module 104 as a trigger.

In the output process, first, in S201, obtaining of the current location of the vehicle 10 is started. This makes it possible to obtain the real-time location of the vehicle 10. Next, in S202, calculation of the current distance is started. This makes it possible to obtain the current distance in real time.

Next, in S203, it is determined whether the current distance is not longer than the first distance. In a case where a negative determination is made in S203, the timing for providing voice guidance to the user of the vehicle 10 in accordance with the first voice data has not arrived, so the process of S203 is executed again. That is, the process of S203 is repeatedly executed until the current distance becomes not longer than the first distance.

In a case where a positive determination is made in S203, it is determined that the current distance is not longer than the first distance and the current distance is longer than the second distance, so a process of generating the first voice data is executed in S204. Then, in S205, it is determined whether or not the predetermined condition is satisfied. In a case where a negative determination is made in S205, the predetermined condition is not satisfied, so the process of S205 is executed again. That is, the process of S205 is repeatedly executed until the predetermined condition is satisfied. In a case where a positive determination is made in S205, it is determined that the current distance is not longer than the first distance and the current distance is longer than the second distance and the predetermined condition is satisfied. In other words, in case a where a positive determination is made in S205, it is determined that it is a suitable timing to provide voice guidance corresponding to the first voice data. Therefore, in S206, the first voice data is output via the voice output module 105.

Next, in S207, it is determined whether the current distance is not longer than the second distance. In a case where a negative determination is made in S207, it is not a suitable timing to provide the user of the vehicle 10 with voice guidance based on the second voice data, so the process of S204 is executed again. That is, the process of S207 is repeatedly executed until the current distance becomes not longer than the second distance.

In a case where a positive determination is made in S207, a process of generating second voice data is executed in S208. Next, in S209, it is determined whether or not the predetermined condition is satisfied. In a case where a negative determination is made in S209, the predetermined condition is not satisfied, and therefore the process of S209 is executed again. That is, the process of S209 is repeatedly executed until the predetermined condition is satisfied. In a case where a positive determination is made in S209, it is determined that the current distance is not longer than the second distance and that the predetermined condition is satisfied. In other words, in a case where a positive determination is made in S209, it is determined that it is a suitable timing to provide voice guidance according to the second voice data. Therefore, in S210, the second voice data is output via the voice output module 105. Then, the output process is terminated.

As described above, the voice guidance system 1 outputs the first voice data and the second voice data according to the current distance. This makes it possible to provide information that is expected to be required by the user of the vehicle 10 according to the vehicle's location. As a result, it is possible to provide the user of the vehicle 10 with suitable information at a suitable time.

### Modification 1

In the above embodiment, the in-vehicle apparatus 100 outputs two types of voice data, namely, the first voice data and the second voice data. However, the in-vehicle apparatus 100 may output 3 or more types of voice data. As an example, the in-vehicle apparatus 100 may acquire three or more pieces of content information in response to a keyword that is determined in advance according to a distance, and generate voice data. In this case, the in-vehicle apparatus 100 may set keywords such that the closer the distance from the current location of the vehicle 10 to the destination, the more detailed content information becomes about the event. This makes it possible to provide voice guidance corresponding to the more detailed content information regarding the event as the vehicle 10 approaches the destination. As a result, it is possible to provide the user of the vehicle 10 with suitable information at a suitable time.

### Modification 2

The in-vehicle apparatus 100 may obtain content information corresponding to a predetermined area location along the scheduled travel route of the vehicle 10 from a website. In this case, the in-vehicle apparatus 100 determines whether the vehicle 10 is location within a predetermined area. In a case where it is determined that the vehicle 10 is location within the predetermined area, the in-vehicle apparatus 100 may obtain the content information corresponding to the predetermined area and output voice data generated from the obtained content information.

Here, the predetermined area may be an area that does not include the destination but includes spots related to the event to be held at the destination. When the voice data corresponding to the above-described spots is output when the vehicle 10 is location within the predetermined area, the user of the vehicle 10 can receive voice guidance corresponding to the spots related to the event. The content information corresponding to the above-described spots related to the event may be, for example, information regarding a factory of a company sponsoring the event. In this case, the spots relevant to the event may be a factory location of a company sponsoring the event. According to present modification, it is possible to provide the user of the vehicle 10 with suitable information at a suitable timing.

### Modification 3

In the above embodiment, an example has been described in which the generation process of the first voice data is performed when the current distance is not longer than the first distance, and the generation process of the second voice data is performed when the current distance is not longer than the second distance. The processes for generating the first voice data and the second voice data do not necessarily have to be performed at these timings. The generation process of the first voice data and the second voice data may be performed, for example, at the timing when the user inputs the destination of the vehicle 10 into in-vehicle apparatus 100. According to this modification, it is possible to provide the user of the vehicle 10 with suitable information at a suitable timing.

### Others

The above-described embodiment is merely an example, and the present disclosure can be modified and implemented as appropriate without departing from the scope of the present disclosure. For example, the processes and configurations described in this disclosure can be freely combined and implemented as long as no technical contradictions arise.

Note that, the processes described as being performed by one device may be shared and executed by a plurality of devices. Alternatively, the processes described as being performed by different devices may be performed by a single device. In a computer system, the hardware configuration by which each function is realized can be flexibly changed.

The technology disclosed herein can be implemented by supplying a computer program (information processing program) or programs configured to implement the functions described in the above description of the embodiments to a computer to cause one or more processors of the computer to read out and execute the program or programs. Such the computer program or programs may be supplied to the computer by a non-transitory, computer-readable storage medium that can be connected to a system bus of the computer or through a network. In one example, a non-transitory computer-readable storage medium may include any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random access memory (RAM), an EPROM, an EEPROM, a magnetic card, a flash memory, an optical card, or any type of medium suitable for storing electronic instructions.

1. An information processing apparatus comprising a controller configured to execute:
obtaining a current location of a vehicle;
calculating a current distance from the current location of a vehicle to a destination of the vehicle; and
outputting, from a sound output device, a voice data generated using a content information according to the current distance;
the content information is selected according to the current distance from among a plurality of candidates of the content information published on a website related to an event to be held at the destination of the vehicle.

2. The information processing apparatus according to the claim 1, wherein,
the outputting the voice data from the voice output device in accordance with the current location is including:
when the current distance is not longer than a first distance and is longer than a second distance, outputting a first voice data generated from a first content information corresponding to the first distance from the voice output device; and
when the current distance is not longer than a second distance, outputting a second voice data generated from a second content information corresponding to the second distance from the voice output device;
wherein,
the second distance is shorter than the first distance,
the first content information includes an information regarding an overview of the event, and the second content information includes an information regarding details of the event.

3. The information processing apparatus according to claim 1 or claim 1, wherein
the outputting the voice data from the voice output device in accordance with the current location is including:
determining whether a spot for providing voice guidance regarding a route to the destination is included within a predetermined range from current location of the vehicle; and
allowing, when the spot where voice guidance is to be performed is not included within the predetermined range, output of the voice data according to the distance corresponding to the current distance.

4. The information processing apparatus according to claim 1, wherein,
the output of the voice data from the voice output device is including:
determining whether a curve is included within a predetermined range from current location of the vehicle; and
allowing, when the curved road is not included within the predetermined range, output of the voice data according to the distance corresponding to the current distance.

5. The information processing apparatus according to claim 1, wherein,
the outputting the voice data from the voice output device in accordance with the current location includes:
summarizing the content information when an amount of information of the content information is not less than a threshold value; and
outputting the voice data generated using the summarized content information to the voice output device in accordance with the current distance.

6. The information processing apparatus according to claim 2, wherein,
the outputting the voice data from the voice output device in accordance with the current location is including:
determining whether the spot for providing voice guidance regarding the route to the destination is included within the predetermined range from current location of the vehicle; and
allowing, when the spot where voice guidance is to be performed is not included within the predetermined range, output of the voice data according to the distance corresponding to the current distance.

7. The information processing apparatus according to claim 2, wherein,
the output of the voice data from the voice output device is including:
determining whether the curve is included within a predetermined range from current location of the vehicle; and
allowing, when the curved road is not included within the predetermined range, output of the voice data according to the distance corresponding to the current distance.

8. The information processing apparatus according to claim 2, wherein,
the outputting the voice data from the voice output device in accordance with the current location includes:
summarizing the content information when an amount of information of the content information is not less than the threshold value; and
outputting the voice data generated using the summarized content information to the voice output device in accordance with the current distance.
